(19) United States
(12) Patent Application Publication
(10) Pub. No.: US 2006/0178161 A1
(43) Pub. Date: Aug. 10, 2006

(54) Method and system for automatically updating user information in a push-to-talk system

(75) Inventor: Won-Suk Jung, Ansan-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/347,174

(22) Filed: Feb. 3, 2006

(30) Foreign Application Priority Data
Feb. 4, 2005 (KR) 2005-10834

(51) Int. Cl. H04B 7/00

(52) U.S. Cl. 455/518

(57) ABSTRACT

Disclosed is a method and system for automatically updating user information in a Push-To-Talk (PTT) system. In the system, when an arbitrary user terminal performs a PTT service using a new connection number and registers user information, a PTT server transmits the new connection number and/or user information to connected group communication target terminals. Therefore, because a connection number can be automatically updated to the new connection number and the user information can be easily provided, user convenience is enhanced.

### PRIORITY

This application claims priority under 35 U.S.C. § 119 to an application entitled “Method and System for Automatically Updating User Information in a Push-To-Talk System” filed in the Korean Intellectual Property Office on Feb. 4, 2005 and assigned Serial No. 2005-10834, the contents of which are incorporated herein by reference.

### BACKGROUND OF THE INVENTION

1. Field of the Invention

The present invention generally relates to a Push-To-Talk (PTT) system, and more particularly to a method and system for automatically updating user information in a PTT service.

2. Description of the Related Art

Although mobile communication systems were originally developed to transmit and receive voice data, they have recently developed the ability to transmit and receive packet data as well as the voice data. Accordingly, a mobile communication subscriber can not only communicate with a person at a remote location by telephone, but also receive multimedia data using the wireless Internet. With the development of the mobile communication systems, the conventional concept of communication service use in a 1:1 relation is developing into the concept of communication service use in a 1:n relation. An example of a service for 1:n communication is a Push-To-Talk (PTT) service. The PTT service enables an arbitrary subscriber and subscribers within a specific group to simultaneously use a voice data transmission/reception service. In the mobile communication system, the PTT service enables several hundreds of subscribers to simultaneously perform group communication, and can cover a network of the whole country such that multi-party communication can be easily performed even when group communication target subscriber terminals are distributed in different regions. According to this group communication function, the PTT service can be used for a multi-party conference, and so on. That is, when the PTT service is used, a plurality of opposite terminals can receive transmitted voice data using a dedicated broadcast channel after an arbitrary subscriber presses a PTT button provided in a user terminal. The voice data transmitted and received in the PTT service has the format of an Internet protocol (IP) packet, such that the PTT service interworks with the wireless Internet packet service.

However, a connection number used in the above-described PTT service is stored by the user's manipulation, and also the stored connection number is changed to a new connection number by the user's manipulation. Accordingly, even when a connection number of PTT service terminals forming a group along with an arbitrary terminal is changed, a connection number stored in the terminal is stored without modification absent the user's intervention. In this case, the user is inconvenienced because a service connection is not made when the user attempts PTT communication with an opposite terminal using a previous connection number. Another communication scheme, for example, a dialed phone communication, must be used such that a changed connection number can be identified. Therefore, if the previous connection number can be automatically updated to a new PTT communication connection number, user convenience can be enhanced. Moreover, user convenience can be further enhanced by providing simple personal information as well as a PTT communication connection number to the PTT service users.

### SUMMARY OF THE INVENTION

It is, therefore, an aspect of the present invention to provide a method and system for updating user information that can automatically update a connection number to a changed connection number in a Push-To-Talk (PTT) service.

It is another aspect of the present invention to provide a method and system for updating user information that can provide user information to an opposite terminal of a group to which a user belongs in a Push-To-Talk (PTT) service.

It is yet another aspect of the present invention to provide a method and system for updating user information that can improve convenience for users of a Push-To-Talk (PTT) service.

The above and other aspects of the present invention can also be achieved by a method for automatically updating user information in a Push-To-Talk (PTT) system, including updating a connection number of an arbitrary mobile communication terminal to a new connection number when the arbitrary mobile communication terminal performs a connection using the new connection number; and transmitting the new connection number according to transmission permission for the new connection number of the arbitrary mobile communication terminal and reception permission of a group communication target terminal when a connection of the group communication target terminal is detected.

The above and other aspects of the present invention can also be achieved by a method for automatically updating user information in a Push-To-Talk (PTT) system, including storing user information and a user information reception target list received from an arbitrary mobile communication terminal in relation to the arbitrary mobile communication terminal; and transmitting the user information according to reception permission of a group communication target terminal when a connection of the group communication target terminal included in the user information reception target list is detected.

The above and other aspects of the present invention can also be achieved by a system for automatically updating user information for Push-To-Talk (PTT), including a plurality of mobile communication terminals for performing group PTT communication therebetween; and a PTT server for updating a connection number of an arbitrary mobile communication terminal of the plurality of mobile communication terminals to a new connection number when the arbitrary mobile communication terminal is connected to the PTT server using the new connection number, and transmitting the new connection number according to transmission permission for the new connection number of the arbitrary mobile communication terminal and reception permission of a group communication target terminal for the new connection number when a connection of the group communication target terminal is detected.

The above and other aspects of the present invention can also be achieved by a system for automatically updating user information for Push-To-Talk (PTT), including a plurality of mobile communication terminals for performing group PTT communication therebetween, and creating and transmitting user information and a user information reception target list according to a user's input; and a PTT server for storing user information and a user information reception target list received from an arbitrary mobile communication terminal of the plurality of mobile communication terminals and mapped to the arbitrary mobile communication terminal, and transmitting the user information according to reception permission of a group communication target terminal included in the user information reception target list when a connection of the group communication target terminal is detected.

### BRIEF DESCRIPTION OF THE DRAWINGS

The above and other aspects and advantages of the present invention will be more clearly understood from the following detailed description taken in conjunction with the accompanying drawings, in which:

FIG. 1 is a block diagram illustrating a structure of a Push-To-Talk (PTT) system for automatically updating user information according to an embodiment of the present invention;

FIG. 2 is a block diagram illustrating a mobile communication terminal to which the present invention is applied;

FIG. 3 is a flow diagram illustrating the operation of the PTT system in accordance with an embodiment of the present invention;

FIG. 4 is a flow chart illustrating the operation of the mobile communication terminal for registering PTT user information in accordance with a second embodiment of the present invention;

FIG. 5 is a flow chart illustrating the operation of a PTT server in accordance with the second embodiment of the present invention;

FIG. 6 is a flow chart illustrating the operation of the mobile communication terminal for receiving PTT user information in accordance with the second embodiment of the present invention; and

FIG. 7 is a flow diagram illustrating the operation of the PTT system in accordance with the second embodiment of the present invention.

### DETAILED DESCRIPTION OF THE PREFERRED EMBODIMENTS

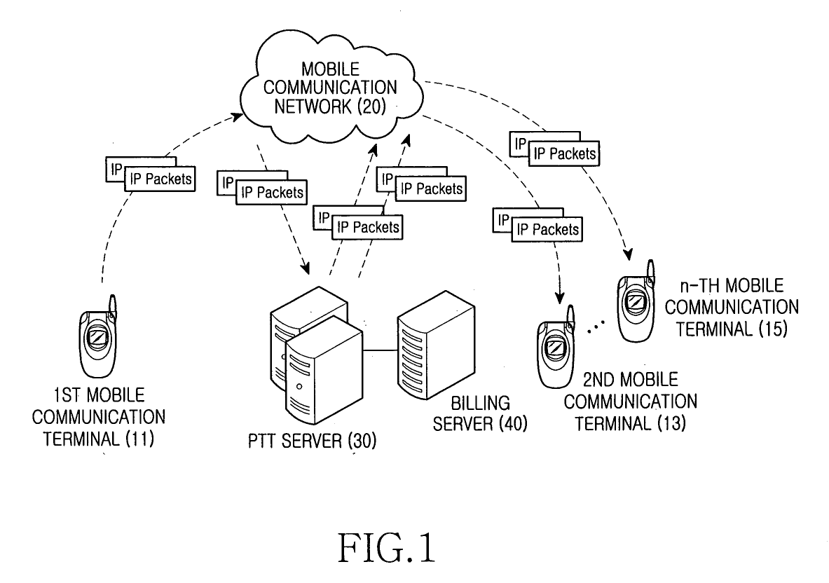

First, a structure of a Push-To-Talk (PTT) service system to which the present invention is applied will be described with reference to FIG. 1 which illustrates a structure of a PTT system for automatically updating user information in accordance with an embodiment of the present invention. The PTT service system includes a plurality of mobile communication terminals 11, 13 and 15, a mobile communication network 20, a PTT server 30 and a billing server 40.

The mobile communication network 20 provides a path for connecting the mobile communication terminals 11, 13 and 15 to the PTT server 30, and may be a communication network based on 3rd generation mobile communication systems (3G) such as Code Division Multiple Access (CDMA) 2000, Wideband Code Division Multiple Access/Universal Mobile Telecommunications System (WCDMA/UMTS), General Packet Radio System (GPRS), and CDMA 2000 Evolution Data and Voice (1 xEV-DV) in accordance with an embodiment of the present invention. Moreover, the mobile communication network 20 interworks with a wireless local area network (WLAN) (not illustrated).

The PTT server 30 serves as a device for controlling a multimedia session based on Session Initiation Protocol (SIP), and performs an operation for registering and authenticating an Internet protocol (IP) multimedia subscriber, an operation for downloading a subscriber profile, and so on. The subscriber profile is comprised of information corresponding to each of PTT service subscribers, and includes a PTT connection number of a mobile communication terminal registered by a PTT service subscriber in the PTT service, a list of group communication targets and specification information associated with a PTT communication function of a mobile communication terminal registered in the PTT service. The PTT service subscriber can register multiple mobile communication terminals in the PTT service, such that the subscriber profile stores information associated with all mobile communication terminals registered by the PTT service subscriber. The PTT server 30 establishes a PTT session between a transmission terminal and reception terminals of group communication target terminals. When the PTT session is established, the PTT server 30 multicasts voice data received from the transmission terminal to the reception terminals of group communication terminal targets through the mobile communication network 20. Moreover, the PTT server 30 collects billing information for terminals that perform PTT communication, and sends the collected billing information to the billing server 40.

When an arbitrary mobile communication terminal performs a connection using a new connection number which is different from an existing connection number in accordance with an embodiment of the present invention, the PTT server 30 updates the existing connection number to the new connection number in a subscriber profile mapped to the connected terminal. Subsequently, when a connection of a group communication target terminal is sensed, the PTT server 30 receives connection number transmission permission from the arbitrary terminal and connection number reception permission from the connected group communication target terminal, sends the new connection number to the group communication target terminal, collects billing information and sends the collected billing information to the billing server 40.

When an arbitrary PTT service subscriber registers a new mobile communication terminal in the PTT service while maintaining PTT service registration of an existing mobile communication terminal, the PTT server 30 notifies a group communication target terminal of the PTT service subscriber that a newly registered mobile communication terminal serving as the group communication target terminal of the PTT service subscriber is present, through a process similar to the process for transmitting the new connection number. Then, the PTT server 30 transmits a connection number of the newly registered mobile communication terminal to a group communication target terminal of the PTT service subscriber. When one PTT service subscriber registers multiple mobile communication terminals in the PTT service, the PTT server 30 sends, to the PTT service subscriber and the group communication target terminal thereof, information about a mobile communication terminal having a PTT communication function suitable for the current PTT service environment among registered mobile communication terminals.

The PTT server 30 sends user information from an arbitrary mobile communication terminal to a group communication target terminal thereof. The user information is information to be transmitted from the user of the arbitrary mobile communication terminal, i.e., the PTT service subscriber, to the group communication target terminal. For example, the user information may be name card information or a message configured by a simple sentence.

Moreover, the PTT server 30 sends information about the pause of the PTT service for the arbitrary PTT service subscriber to the group communication target terminal thereof. The information about the PTT service pause is information in the case where the PTT service is temporarily stopped in a state in which the arbitrary PTT service subscriber does not cancel PTT service subscription, or in the case where a mobile communication terminal registered in the PTT service cannot be used. In this case, when group communication target terminals of the arbitrary PTT service subscriber are connected to the PTT server 30 and retrieve connected group communication target terminals, only a state in which a mobile communication terminal of the arbitrary PTT service subscriber is not connected is always identified. Because the reason why the terminal is not connected cannot be identified, the user is inconvenienced when using the PTT service. Accordingly, if the PTT server 30 sends, to the group communication target terminals, information indicating that the arbitrary subscriber has paused the PTT service, improves the PTT service.

The billing server 40 determines charges associated with an arbitrary terminal according to the billing information received from the PTT server 30.

The mobile communication terminals 11, 13 and 15 are included in n mobile communication terminals including the first mobile communication terminal 11, the second mobile communication terminal 13, and the n-th mobile communication terminal 15. The mobile communication terminals 11, 13 and 15 are classified into a plurality of groups including a plurality of mobile communication terminals according to the user's selection. A communication link is formed between terminals belonging to each group through the mobile communication network 20, such that voice communication between multiple parties can be simultaneously performed. In the following description, the first mobile communication terminal 11 of the multiple mobile communication terminals is connected using a new connection number or is designated as a user terminal whose user information is registered, and the remaining terminals are regarded as the group communication target terminals 13 and 15.

In accordance with an embodiment of the present invention, the multiple mobile communication terminals 11, 13 and 15 create user information and a user information reception target list according to the user's intention, and send the created user information and the created user information reception target list to the PTT server 30 when the terminals 11, 13 and 15 are connected to the PTT service. The user information is information to be transmitted from the user of an arbitrary mobile communication terminal to the group communication target terminals, and may include, for example, name card information or a message configured by a simple sentence. The PTT server 30 registers the user information by storing the received user information and the user information reception target list in relation to the arbitrary mobile communication terminal. Subsequently, when a connection of a mobile communication terminal included in the user information reception target list is detected, the PTT server 30 sends the user information according to reception permission of the user information of the detected mobile communication terminal. Through this process, the multiple mobile communication terminals 11, 13 and 15 can receive and store the user information from the PTT server 30 when connecting to the PTT service.

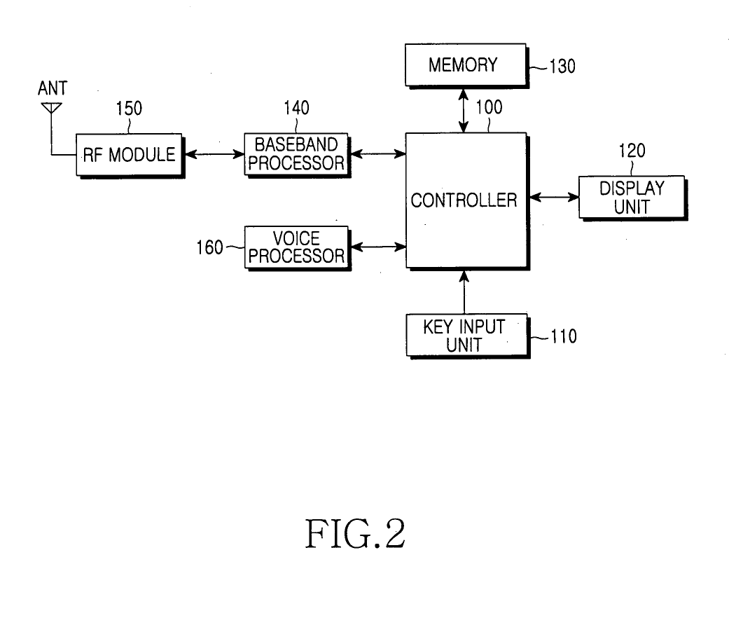

A structure of the mobile communication terminal is illustrated in FIG. 2. FIG. 2 is a block diagram illustrating the mobile communication terminal to which the present invention is applied. As illustrated in FIG. 2, the mobile communication terminal includes a controller 100, a key input unit 110, a display unit 120, a memory 130, a baseband processor 140 and a radio frequency (RF) module 150.

The key input unit 110 includes numeric keys such as 0˜9, * and # keys, a plurality of optional function keys, mapped to various functions, provided in the mobile communication terminal, and a PTT communication key. The key input unit 110 provides the controller 100 with key input data mapped to a key pressed by the user.

A voice processor 160 is coupled to the controller 100, a microphone (not shown) and speaker (not shown). The microphone and speaker are used for phone communication and voice recording functions.

The RF module 150 transmits a radio signal to, and/or receives a radio signal from, a mobile communication base station through an antenna. The RF module 150 modulates a transmission signal input from the controller 100 through the baseband processor 140 to send an RF signal through the antenna. The RF module 150 demodulates an RF signal received through the antenna to output the demodulated signal to the controller 100 through the baseband processor 140. Moreover, the RF module 150 receives a paging channel and outputs system information to the controller 100. The baseband processor 140 processes a baseband signal transmitted and received between the RF module 150 and the controller 100.

The memory 130 stores a program for processing and control operations of the controller 100, reference data, various data capable of being updated, connection numbers of group communication target terminals in the PTT communication service, and so on. The memory 130 provides a memory for the controller's use 100. Moreover, the memory 130 stores the user information and the user information reception target list generated by a user information creation menu in accordance with the present invention. The user information includes name card information and short text message information. The user information is configured using information about a user name, an office place, a connection number of another communication means, an electronic mail (E-mail) address, and so on, or is configured using a text message of a including a basic sentence. The user information reception target list includes a list of mobile communication terminals to receive the user information, and includes group communication target terminals selected by the user from information of the PTT service group communication target terminals stored in advance in the mobile communication terminal.

The controller 100 processes and controls the overall function of the mobile communication terminal. For example, the controller processes and controls a phone call, data communication, and so on. When connecting to the PTT server 30, the controller 100 sends the user information and the user information reception target list to the PTT server 30 in accordance with an embodiment of the present invention. When performing a PTT communication connection, the controller 100 stores, in the memory 130, user information of another mobile communication terminal sent from the PTT server 30 through a process for identifying reception permission.

In an embodiment of the present invention, the user information and the user information reception target list are sent in the form of an IP packet. The transmission and reception of data for establishing a PTT session between mobile communication terminals in the PTT service are accomplished using a Transmission Control Protocol (TCP) and a SIP. After the PTT session is established, the transmission and reception of the voice data are accomplished using a User Datagram Protocol (UDP) and a Real-time Transport Protocol (RTP). In accordance with the present invention, the user information and the user information reception target list are sent to the PTT server 30 in the form of an IP packet according to the TCP and SIP when connecting to the PTT server 30.

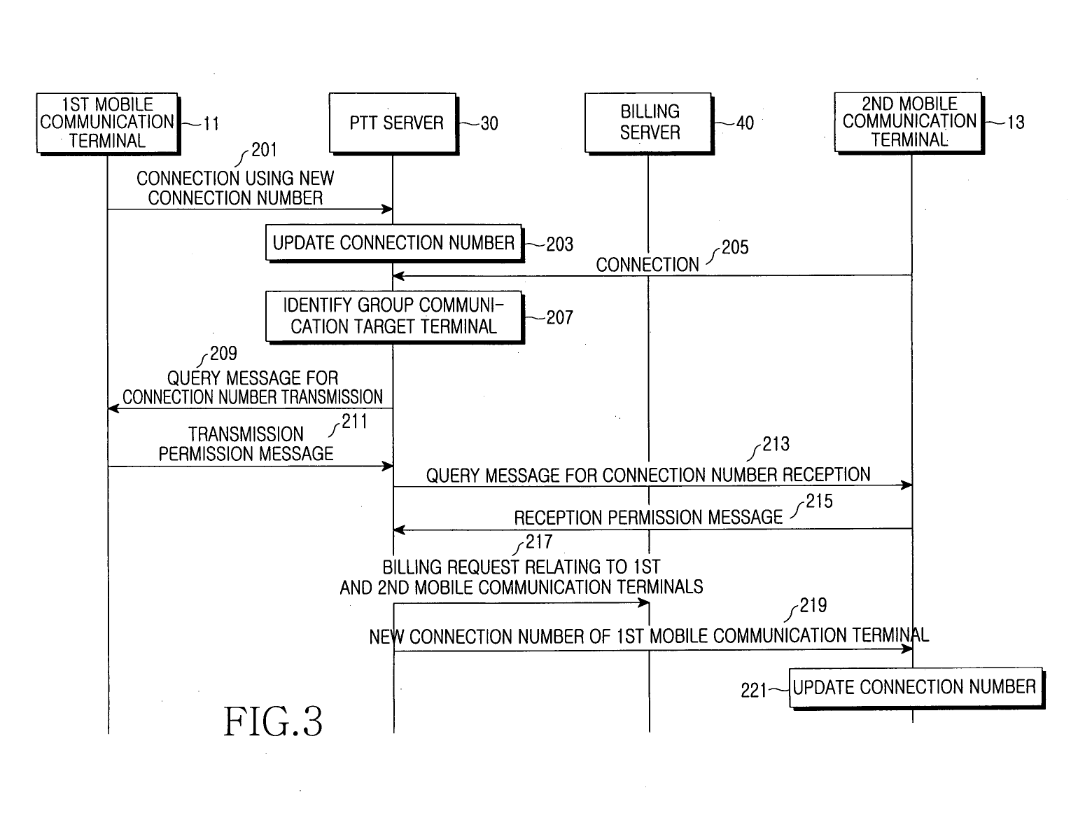

An automatic update process for a new connection number when an arbitrary mobile communication terminal starts the PTT service using the new connection number in the PTT system of the present invention will now be described with reference to FIG. 3.

FIG. 3 is a flow diagram illustrating the operation of the PTT system in accordance with an embodiment of the present invention. It should be noted that in accordance with the present embodiment of the present invention, the first mobile communication terminal 11 is assumed to be a user terminal, and the second mobile communication terminal 13 is assumed to be designated as one of the group communication target terminals.

The first mobile communication terminal 11 is connected to the PTT server 30 using a new connection number in step 201. As the first mobile communication terminal 11 performs a connection using the new connection number, the PTT server 30 retrieves a profile corresponding to the first mobile communication terminal 11 and updates a previous connection number to the new connection number in step 203. Subsequently, when a connection of the second mobile communication terminal 13 is made in step 205, the PTT server 30 proceeds to step 207. The PTT server 30 determines that the second mobile communication terminal 13 is a group communication target terminal of the first mobile communication terminal 11 in step 207, and proceeds to step 209. The PTT server 30 sends, to the first mobile communication terminal 11, a query message requesting whether the first mobile communication terminal 11 wants the new access number to be transmitted to the second mobile communication terminal 13 in step 209.

Upon receiving the query message relating to the connection number transmission, the first mobile communication terminal 11 sends a transmission permission or rejection message to the PTT server 30 according to the user's selection. That is, the user can determine a group communication target terminal to which the new connection number is sent through the query message relating to the connection number transmission, and can transmit the new connection number only to a desired group communication target. If the first mobile communication terminal 11 is connected to the PTT server 30, the query message relating to the connection number transmission is sent in the form of an IP packet. However, if the first mobile communication terminal 11 is not presently connected to the PTT server 30, the message is sent in the form of a text message.

In response to the query message relating to the connection number transmission, the first mobile communication terminal 11 at a user's request sends a transmission permission message to the PTT server 30 in step 211. Alternatively, rather than the transmission permission message, the transmission rejection message can be sent to the PTT server 30 according to a user's selection. Upon receiving the transmission permission message, the PTT server 30 sends, to the second mobile communication terminal 13, a query message asking if the second mobile communication terminal 13 wants to receive the new connection number of the first mobile communication terminal 11 in step 213. The second mobile communication terminal 13 sends a reception permission or rejection message to the PTT server 30 according to the user's selection. That is, the user determines whether to receive the new connection number of the first mobile communication terminal 11 and update the connection number through the query message relating to the connection number reception. In step 215, the second mobile communication terminal 13 sends the reception permission message to the PTT server 30. When the reception rejection message is received, the new connection number is not transmitted to the second mobile communication terminal 13, and update procedure of the new connection number is completed. And, it can be constituted that it is informed to the first mobile communication terminal 11 that the second mobile communication terminal 13 rejects a receipt of the new connection number. As the PTT server 30 receives the reception permission message, the PTT server sends a billing request for charging fees related to the first mobile communication terminal 11 and the second mobile communication terminal 13 to the billing server 40 in step 217 and proceeds to step 219. In step 219, the PTT server 30 sends the new connection number of the first mobile communication terminal 11 to the second mobile communication terminal 13. In step 221, the second mobile communication terminal 13 updates the connection number of the first mobile communication terminal 11 to the new connection number received.

When the connection number of an arbitrary PTT service subscriber is updated, the updated connection number can be automatically sent to the group communication target terminal in accordance with the present invention. The above-described transmission process can be used also in the case where the arbitrary PTT service subscriber registers a plurality of mobile communication terminals in the PTT service and has a plurality of connection numbers. That is, when the arbitrary PTT service subscriber registers another mobile communication terminal in the PTT service in addition to the existing PTT service mobile communication terminal and is assigned the new connection number, the PTT server 30 stores information about the new PTT service mobile communication terminal in a profile mapped to the arbitrary subscriber. Subsequently, when a connection of a group communication target terminal of the PTT service subscriber is detected, the PTT server 30 sends, to the PTT service mobile communication terminal of the arbitrary subscriber, a query message relating to connection number transmission. When the PTT server 30 receives a transmission permission message in response to the query message relating to connection number transmission, the PTT server 30 sends, to the group communication target terminal, a query message relating to connection number reception. When the PTT server 30 receives a reception permission message from the group communication target terminal, the PTT server 30 sends a new connection number along with a message indicating that a new PTT service mobile communication terminal (e.g. the arbitrary PTT service subscriber in this example) has been added.

Whenever the PTT server 30 transmits a new connection number of the user terminal to the group communication target terminal, the PTT server 30 determines if the user terminal wants to transmit the access number and performs the transmission. Alternatively, the user may provide in advance a list of group communication terminals, i.e., a list of connection number reception targets, to which the new connection number is to be sent, to the PTT server 30, such that the connection number can be automatically sent only to target terminals.

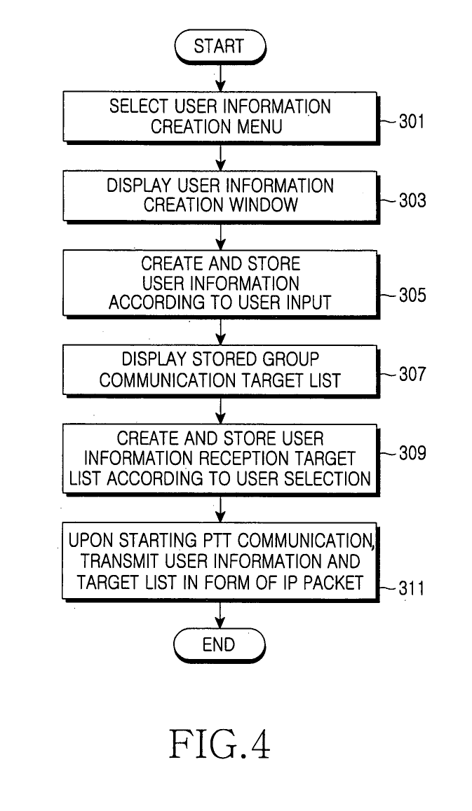

A second embodiment of the present invention in which personal information of a user as well as a new connection number is automatically sent, such that an update operation is automatically performed will now be described. This embodiment is similar to the previous embodiment shown in FIG. 2 and includes additional features. In the second embodiment of the present invention, when the user creates user information and a user information reception target list through an arbitrary mobile communication terminal configured as illustrated in FIG. 2 and performs registration by sending the created information and list to the PTT server 30, the PTT server 30 stores the received user information and the received user information reception target list mapped to the arbitrary mobile communication terminal. Subsequently, when a connection of a mobile communication terminal included in the user information reception target list is detected, the PTT server 30 sends the user information according to reception permission. This process will be described in more detail with reference to FIGS. 4 to 6.

First, a process in which the mobile communication terminal creates and sends the user information and the user information reception target list, will be described with reference to FIG. 4.

FIG. 4 is a flow chart illustrating the operation of the mobile communication terminal for registering user information in accordance with the second embodiment of the present invention. When a user information creation menu is selected in step 301, the controller 100 proceeds to step 303 in which the controller 100 displays a user information creation window and thereafter proceeds to step 305. The user information creation window may be name card information (e.g. a V-card or other user-specific identifying information) input window to which information specific to a user and/or business etc., such as a user's name, a user's business name including personal and/or business and/or address office place, a connection number of another communication means (e.g. a work number, a home number, a fax number, etc.), and an E-mail address of the user, and so on can be input in accordance with an embodiment of the present invention. In accordance with another embodiment of the present invention, the user information creation window may be a text message input window to which a text message (such as a simple sentence) can be input. The user can input name card information and a message of a simple sentence.

The controller 100 completes user information creation according to the user's input in step 305, and proceeds to step 307. The controller 100 displays a stored PTT group communication target list in step 307 and proceeds to step 309. The user selects a group communication target to which the user information is provided, from the displayed PTT group communication target list. The controller 100 creates the user information reception target list according to the user's selection in step 309 and proceeds to step 311. The controller 100 sends, to the PTT server 30, the stored user information and the stored user information reception target list in the form of an IP packet in step 311 and ends an operation process.

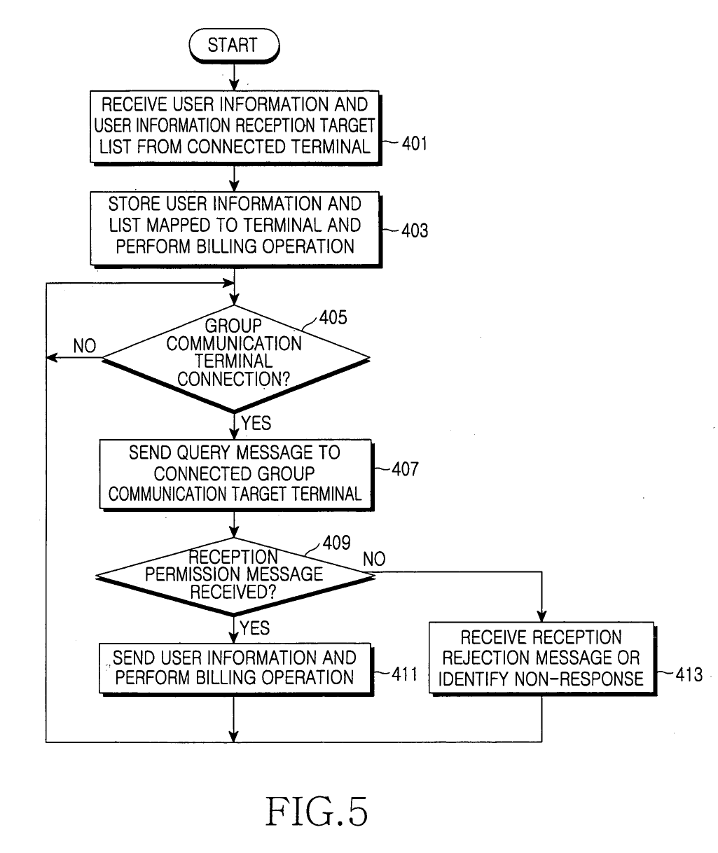

Upon receiving the user information and the user information reception target list, the PTT server 30 operates as illustrated in FIG. 5. FIG. 5 is a flow chart illustrating the operation of the PTT server in accordance with the second embodiment of the present invention.

As illustrated in FIG. 5, when the PTT server 30 receives user information and a user information reception target list from a connected mobile communication terminal in step 401, the PTT server 30 proceeds to step 403. In step 403, the PTT server 30 registers the user information by storing the received user information and the received user information reception target list in a profile corresponding to the mobile communication terminal, and sends a billing request relating to the corresponding mobile communication terminal to the billing server 40. Subsequently, when a connection of a group communication terminal included in the user information reception target list is detected in step 405, the PTT server 30 proceeds to step 407. The PTT server 30 sends, to the connected group communication terminal, a query message requesting whether the connected group communication terminal desires to receive the user information in step 407. Subsequently, in step 409 when a reception permission message is received from the group communication terminal, the PTT server 30 proceeds to step 411. However, when the reception permission message is not received within a predetermined period of time, the PTT server 30 proceeds to step 413. In step 413 it is determined whether a reception rejection message is received or whether a non response is detected in step 413, and thereafter the PTT server 30 proceeds to step 405 without transmitting user information.

In step 411, the PTT server 30 sends the user information to the connected group communication terminal and sends a billing request to the billing server 30. Then, the PTT server 30 proceeds to step 405. Until all connections of group communication terminals included in the user information reception target list are detected, the operation process of steps 405 to 413 is repeatedly performed.

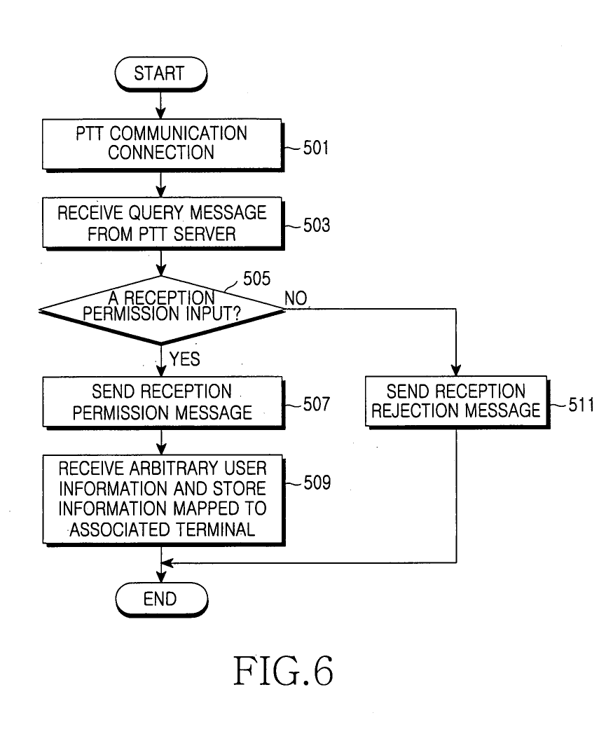

An operation process of a mobile communication terminal for receiving the user information according to the operation process of the PTT server 30 is illustrated in FIG. 6.

FIG. 6 is a flow chart illustrating the operation of the mobile communication terminal for receiving user information in accordance with a second embodiment of the present invention. The mobile communication terminal is configured as illustrated in FIG. 2. Referring to FIGS. 2 and 6, the controller 100 of the mobile communication terminal for receiving the user information is connected to a PTT server 30 and is capable of performing a PTT communication in step 501, and proceeds to step 503. The controller 100 receives a query message (i.e. a query message for connection number reception asking whether the mobile communication terminal desires to receive arbitrary user information from the PTT server 30 in step 503. The user can identify an opposite terminal to which the user information is provided through the query message relating to the user information and can determine whether to send a reception permission message to the PTT server 30. Subsequently, the controller 100 determines if an input associated with the received query message is received from the user in step 505. In other words, the controller determines whether an input corresponding to a “reception permission” or a “reception rejection” is entered by the user. If a reception permission input is detected, the controller 100 proceeds to step 507. However, if a reception rejection input is detected, the controller 100 proceeds to step 511. The input associated with reception is accomplished through a key input corresponding to a reception permission or a reception rejection.

The controller 100 sends a reception permission message to the PTT server 30 in step 507, and proceeds to step 509. The controller 100 receives the arbitrary user information, stores the received user information in a storage area mapped to an associated mobile communication terminal in step 509, and ends the operation process.

On the other hand, the controller 100 sends a reception rejection message according to the reception rejection input in step 511 and ends the operation process.

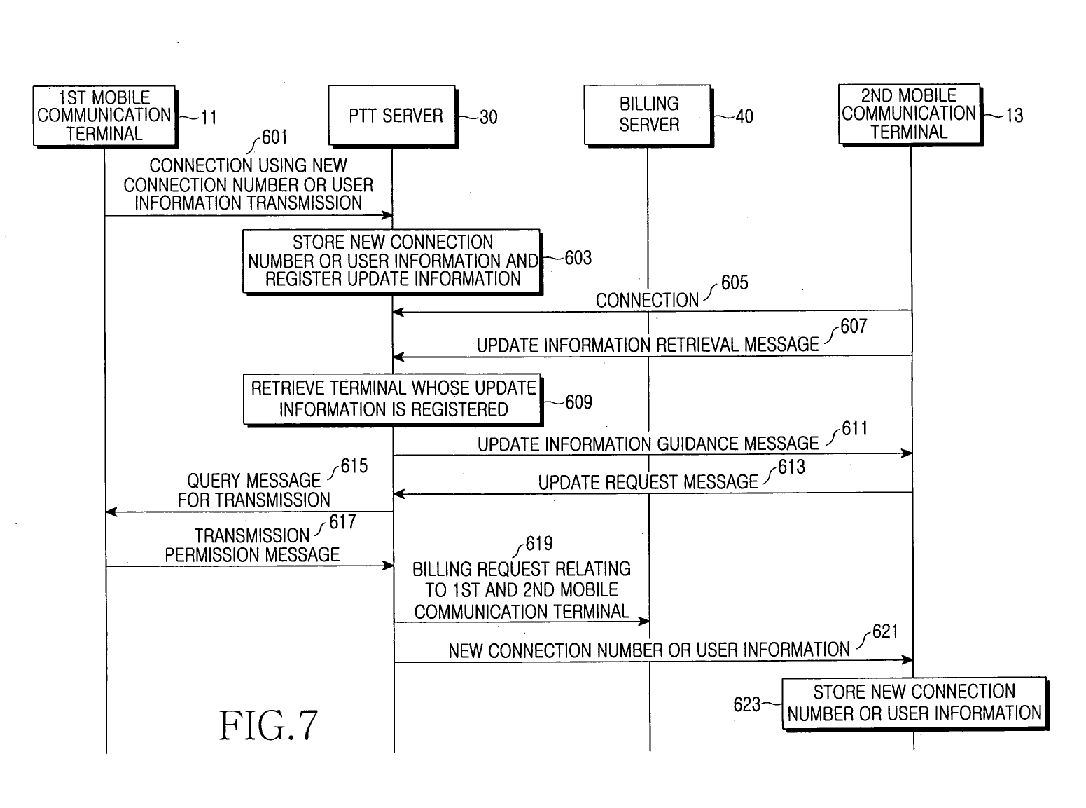

When an update information request is received from a group communication target terminal after a user terminal performs a connection to a PTT server 30 through a new connection number or registers user information, the PTT server 30 sends the new connection number or user information to the group communication target terminal making the information request according to information transmission permission of the user terminal in accordance with another embodiment of the present invention. This process will be described with reference to FIG. 7.

FIG. 7 is a flow diagram illustrating the operation of the PTT system in accordance with the second embodiment of the present invention. As illustrated in FIG. 7, the first mobile communication terminal 11 serving as a user terminal is connected to the PTT server 30 through a new connection number or sends user information in step 601. The PTT server 30 performs an update operation for the new connection number in a profile of the first mobile communication terminal 11 or registers updated user information by storing the updated user information in step 603. Subsequently, the second mobile communication terminal 13 is connected to the PTT server 30 in step 605. When the second mobile communication terminal 13 is connected the PTT server 30, the second mobile communication terminal 13 sends, to the PTT server 30, an update information retrieval message for identifying new update information associated with group communication target terminals. The PTT server 30 retrieves a terminal whose update information is registered from group communication target terminals of the second mobile communication terminal 13 according to the reception of the update information retrieval message in step 609. If a terminal whose update information is registered is detected, an update information guidance message is sent to the second mobile communication terminal 13 in step 611. The update information guidance message is configured by a user name of the terminal whose update information is registered and simple guidance about content of the information. For example, the update information guidance message can be configured by a user name of the first mobile communication terminal 11 and a changed connection number, or can be configured by the user name and user information associated with the first mobile communication terminal 11. The user can determine the reception of updated information through the update information guidance message. Upon receiving the update information guidance message, the second mobile communication terminal 13 sends an update information request message to the PTT server 30 in step 613. When receiving the update information request message, the PTT server 30 sends, to the first mobile communication terminal 11, a query message asking if the terminal 11 wants information to be sent in step 615. Upon receiving the query message, the first mobile communication terminal 11 sends a transmission permission or rejection message to the PTT server 30 according to the user's selection. The first mobile communication terminal 11 sends the transmission permission message to the PTT server 30 in step 617.

If the PTT server 30 receives the transmission permission message, the PTT server 30 sends, to the billing server 40, a billing request relating to the first mobile communication terminal 11 and the second mobile communication terminal 13 in step 619. Thereafter, the PTT server 30 sends a new connection number or user information of the first mobile communication terminal 11 to the second mobile communication terminal 13 in step 621. The second mobile communication terminal 13 stores the received new connection number or user information mapped to the first mobile communication terminal 11 in step 623.

As described above, the present invention can perform an update operation for a new connection number or user information of an arbitrary mobile communication terminal through the PTT service at a PTT communication time.

As described above, the present invention sends a new connection number or user information to group communication target terminals connected to a PTT server when an arbitrary user terminal performs a PTT service using the new connection number or registers the user information. Accordingly, the new connection number is automatically updated and user information can be easily provided, such that the convenience for a user can be improved.

What is claimed is:

1. A method for automatically updating user information in a Push-To-Talk (PTT) system, comprising:
updating a connection number of an arbitrary mobile communication terminal to a new connection number, when the arbitrary mobile communication terminal performs a connection using the new connection number; and
sending the new connection number when a connection of a group communication target terminal is detected.

2. A method for automatically updating user information in a Push-To-Talk (PTT) system, comprising:
updating a connection number of an arbitrary mobile communication terminal to a new connection number, when the arbitrary mobile communication terminal performs a connection using the new connection number; and
transmitting the new connection number according to a transmission permission message for the new connection number of the arbitrary mobile communication terminal and a reception permission message of a group communication target terminal, when a connection of the group communication target terminal is detected.

3. The method of claim 2, wherein the transmitting step comprises:
sending, to the arbitrary mobile communication terminal, a first query message requesting whether the arbitrary mobile communication terminal desires the new connection number to be transmitted to the group communication target terminal, when the group communication target terminal performs a connection;
sending, to the group communication target terminal, a second query message requesting whether the group communication target terminal desires to receive the new connection number, when the transmission permission message is received from the arbitrary mobile communication terminal; and
sending the new connection number to the group communication target terminal, when the reception permission message is received from the group communication target terminal.

4. The method of claim 3, wherein the first query message is configured using:
an Internet protocol (IP) packet, if the mobile communication terminal is connected to the PTT system; and
a text message, if a connection between the mobile communication terminal and a PTT server is terminated.

5. The method of claim 2, wherein the transmission permission message for the new connection number corresponds to an existing reception target list transmitted from the mobile communication terminal.

6. The method of claim 2, further comprising:
performing a billing operation for the arbitrary mobile communication terminal and the group communication target terminal.

7. A method for automatically updating user information in a Push-To-Talk (PTT) system, comprising:
storing user information and a user information reception target list received from an arbitrary mobile communication terminal in relation to the arbitrary mobile communication terminal; and
transmitting the user information when a connection of a group communication target terminal included in the user information reception target list is detected.

8. A method for automatically updating user information in a Push-To-Talk (PTT) system, comprising:
storing user information and a user information reception target list received from an arbitrary mobile communication terminal in relation to the arbitrary mobile communication terminal; and
transmitting the user information according to reception permission of a group communication target terminal when a connection of the group communication target terminal included in the user information reception target list is detected.

9. The method of claim 8, wherein the user information includes at least one of a name, an address, an business address, at least one connection number and an electronic mail (E-mail) address associated with the user.

10. The method of claim 9, wherein the user information is information included in one of a V-card and a name card information.

11. The method of claim 8, wherein the user information is configured using a text message.

12. The method of claim 8, further comprising:
performing a billing operation for the arbitrary mobile communication terminal and the group communication target terminal.

13. The method of claim 8, wherein the user information and the user information reception target list are configured using a an Internet protocol (IP) packet.

14. A method for automatically updating user information in a Push-To-Talk (PTT) system, comprising:
when an arbitrary mobile communication terminal performs a connection using a new connection number and transmits user information, performing an update operation for the new connection number mapped to the arbitrary mobile communication terminal, storing user information mapped to the arbitrary mobile communication terminal, and performing information registration; and
transmitting the new connection number and the user information according to transmission permission for information corresponding to the arbitrary mobile communication terminal, when a connected group communication target terminal is identified by the information registration and a request for registered information is transmitted.

15. A system for automatically updating user information for a Push-To-Talk (PTT) feature, comprising:
a plurality of mobile communication terminals for performing group PTT communication therebetween; and
a PTT server for updating a connection number of an arbitrary mobile communication terminal of the plurality of mobile communication terminals to a new connection number when the arbitrary mobile communication terminal is connected to the PTT server using the new connection number, and transmitting the new connection number according to transmission permission information for the new connection number of the arbitrary mobile communication terminal and reception permission information of a corresponding group communication target terminal, when a connection of the group communication target terminal is sensed.

16. The system of claim 15, further comprising:
a billing server for processing a billing operation corresponding to at least one of the arbitrary mobile communication terminal and the group communication target terminal.

17. A system for automatically updating user information for Push-To-Talk (PTT) feature, comprising:
a plurality of mobile communication terminals for performing group PTT communication therebetween, and creating and transmitting user information and a user information reception target list corresponding to an arbitrary mobile communication terminal of the plurality of mobile communication terminals according to a user's input; and
a PTT server for storing the user information and the user information reception target list received from the arbitrary mobile communication terminal and mapped to the arbitrary mobile communication terminal; and transmitting the user information according to reception permission information corresponding to a group communication target terminal included in the user information reception target list when a connection of the group communication target terminal is detected.

18. A method for automatically updating user information in a Push-To-Talk (PTT) system, comprising:
registering a new mobile communication terminal in a PTT service in response to a request of an arbitrary PTT service subscriber, and registering a plurality of PTT service mobile communication terminals associated with the arbitrary PTT service subscriber; and
transmitting information about the plurality of PTT service mobile communication terminals to a group communication target terminal of the arbitrary PTT service subscriber according to transmission permission information of the arbitrary PTT service subscriber.

19. The method of claim 18, wherein the information about the plurality of PTT service mobile communication terminals includes information indicating that the new mobile communication terminal has been added as a PTT service mobile communication terminal and further includes an assigned connection number.

20. The method of claim 18, wherein the information about the plurality of PTT service mobile communication terminals includes information corresponding to a mobile communication terminal having a PTT communication function specification suitable for a current PTT service environment among stored PTT communication function specifications provided in the plurality of PTT service mobile communication terminals.

21. A method for automatically updating user information in a Push-To-Talk (PTT) system, comprising the steps of:
registering a plurality of PTT service mobile communication terminals associated with an arbitrary subscriber in a PTT service; and
transmitting, to the arbitrary subscriber and a group communication target terminal of the arbitrary subscriber, information about a mobile communication terminal with a PTT communication function specification suitable for a current PTT service environment among stored PTT communication function specifications provided in the plurality of PTT service mobile communication terminals.
